(19) United States
(12) Patent Application Publication
(10) Pub. No.: US 2023/0244894 A1
(43) Pub. Date: Aug. 3, 2023

(54) SYSTEM AND METHOD FOR AUTOMATION OF REALTOR SERVICES AND TRANSACTIONS USING INFORMATION PROVIDED THROUGH SCANNING REUSABLE QUICK RESPONSE (QR) CODES

(71) Applicant: Mitch WILKINS, Muncie, IN (US)

(72) Inventor: Mitch WILKINS, Muncie, IN (US)

(21) Appl. No.: 17/885,533

(22) Filed: Aug. 10, 2022

Related U.S. Application Data
(60) Provisional application No. 63/231,245, filed on Aug. 10, 2021.

(51) Int. Cl. G06K 19/06; G06F 16/955

(52) U.S. Cl. CPC G06K 19/06037; G06F 16/9554

(57) ABSTRACT

A system and method are disclosed for implementing reusable QR codes o automate information sharing. The system includes accessing information associated with reusable QR codes, which may be embedded into or displayed on a sign, a paper product, or a shirt. The access allows automation of services or sale of goods as well as assists in and automates collecting necessary information for future contact/follow-up as well entry of information necessary for a sales transaction, especially as related to real property sales.

### CROSS REFERENCE TO RELATED APPLICATIONS

This application claim priority to the U.S. Provisional Application Ser. No. 63/231,245 filed on Aug. 10, 2021 and titled SYSTEM AND METHOD FOR IMPLEMENTING REUSABLE QR CODES by Mitch WILKINS, the entire disclosure of which is incorporated herein by reference.

### FIELD OF THE TECHNOLOGY

The invention is in the field of computer systems and, more specifically, related to systems and methods for using reusable Quick Response (QR) codes and tags with near-filed communication (NFC) capability.

### BACKGROUND

Known systems and methods are inefficient for connecting customers with information needed to make a purchase are slow and limited. For example, most buyers or clients want immediate access to information about the item being purchased. For example, a potential home buyer wants access to home related information.

A patron at a restaurant or bar wants access to a menu, quick service, and easy payment processing for purchasing and tipping.

Politicians want to provide voters with immediate access to information about the politician and means for quick payment of financial support.

Patients want to have their medical information readily available and medical service providers want access to a patient's medical information immediately and quickly.

Sadly, information exchange using known systems is slow, especially when the product involves an intermediary between the seller and buyer. Some known systems use dynamic QR codes to improve information exchange. However, these codes fail to provide the necessary efficiency and are not able to change the URL connected to the QR code as many times as needed and within seconds.

Therefore, what is needed is a system and method that implements reusable Quick Response (QR) codes and near-filed communication (NFC) tags to automate information sharing, product purchasing, and lead generation.

### SUMMARY

The invention discloses a system and method that implements reusable Quick Response (QR) codes to automate information sharing, immediate reprogramming, and lead generation. The system includes reusable QR codes as a feature inside the system or application (App) as well as embedded a CRM within the reusable QR codes to automatically become a lead generator. The system and method also include using NFC tags for sharing information and making payments for purchases.

### BRIEF DESCRIPTION OF THE DRAWINGS

In order to more fully understand the invention, reference is made to the accompanying drawings. The invention is described in accordance with the aspects and embodiments in the following description with reference to the drawings or figures (FIG.), in which like numbers represent the same or similar elements. Understanding that these drawings are not to be considered limitations in the scope of the invention, the presently described aspects and embodiments and the best mode of the invention are described with additional detail through use of the accompanying drawings.

FIG. 1 shows a billboard displaying a reusable QR code in accordance with the various aspects and embodiments of the invention.

FIG. 2 shows a reusable QR code and a link to a video explaining the use thereof in accordance with the various aspects and embodiments of the invention.

FIG. 3 shows a user interface in accordance with the various aspects and embodiments of the invention.

FIG. 4 shows a reusable QR code on a sign in accordance with the various aspects and embodiments of the invention.

FIG. 5 shows a user interface in accordance with the various aspects and embodiments of the invention.

FIG. 6 shows a user interface with multiple message exchanges in accordance with the various aspects and embodiments of the invention.

FIG. 7 shows a user interface in accordance with the various aspects and embodiments of the invention.

FIG. 8 shows a user interface in accordance with the various aspects and embodiments of the invention.

FIGS. 9A-9C show flowcharts of a process in accordance with the various aspects and embodiments of the invention. FIG. 10 shows a wearable reusable QR code in accordance with various aspects and embodiments of the invention.

FIG. 11 shows a server in accordance with various aspects and embodiments of the invention.

FIG. 12 shows a block diagram of a system-on-chip (SoC) in accordance with various aspects and embodiments of the invention.

FIG. 13 shows a rotating disk non-transitory computer readable medium, in accordance with various aspects and embodiments of the invention.

FIG. 14 shows a flash random access memory non-transitory computer in accordance with various aspects and embodiments of the invention.

FIG. 15 shows the bottom side of a computer processor based SoC in accordance with various aspects and embodiments of the invention.

FIG. 16 shows the top side of a computer processor based SoC in accordance with various aspects and embodiments of the invention.

### DETAILED DESCRIPTION

To the extent that the terms “including”, “includes”, “having”, “has”, “with”, or variants thereof are used in either the detailed description and the claims, such terms are intended to be inclusive in a similar manner to the term “comprising”. The invention is described in accordance with the aspects and embodiments in the following description with reference to the figures (FIGS.), in which like numbers represent the same or similar elements.

Reference throughout this specification to “one embodiment,” “an embodiment,” or “in accordance with some aspects” and similar language means that a particular feature, structure, or characteristic described in connection with the various aspects and embodiments are included in at least one embodiment of the invention. Thus, appearances of the phrases “in accordance with an aspect,” “in accordance with one embodiment,” “in an embodiment,” “in certain embodiments,” and similar language throughout this specification refer to the various aspects and embodiments of the invention. It is noted that, as used in this description, the singular forms “a,” “an” and “the” include plural referents, unless the context clearly dictates otherwise.

The described features, structures, or characteristics of the invention may be combined in any suitable manner in accordance with the aspects and one or more embodiments of the invention. In the following description, numerous specific details are recited to provide an understanding of various embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring the aspects of the invention.

The ranges of values provided above do not limit the scope of the present invention. It is understood that each intervening value, between the upper and lower limit of that range and any other stated or intervening value in that stated range, is encompassed within the scope of the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

The advantages of the system are discussed herein and include: reducing costs for lead generation; eliminating all of steps that slow down the process of engaging an establishment for purchase of products or access to services; automating lead generation for service providers and sellers; no more paper “house listing” or printed sheets with details about the item for sale. No more customer searching for your listing when driving past the house or item for sale, which can take less than seconds; a client relationship management (CRM) system is used so if they don't love the items for sale, then they filled out their dream house survey and the system finds matches on listing sites or the multiple listing service (MLS) and auto sends to the buyer making the request.

On the other hand, if nothing on the market in their area exists then “queue” the information or listing so as soon as one becomes available it is sent to the potential buyer with the need for an intermediary to get involved. This eliminates 95% of the realtor's daily computerized tasks. All scheduling from (viewings, listing meetings, interviews, Pre approval, financing, inspections, pest inspections, title company, stager . . . etc.) all get automatically scheduled by client through the software; reduces emailing and missed communication, such as triangle emailing back and forth. In accordance with the various aspects and embodiments of the invention, the overall process allows for sharing listing information with friends and family if the buyers want to consider a purchase; reduces number of “viewings/showings” and number of hours an intermediary or seller spends showing an item (car or house) as there is a 3D image, floor plan, or tours thereby showing the item or house so they only see it in person when they love what they see.

In accordance with the various aspects and embodiments of the invention, the advantage is reduction in showings of the item in person (reduction of 80%) and increased conversion rate on people that actually or finally see the item or house; improving customer relations and less time spent on trivial data back and forth.

In accordance with some aspects and embodiments of the invention, QRealtor is a product which allows a realtor to use reusable QR codes. In accordance with the various aspects and embodiments of the invention, a reusable QR code is a code that can be reassigned to new data and the data associated with the QR code can be updated, changed, or altered without altering the appearance of the QR code. For example, a URL associated with a reusable QR code can be updated or changed to a new URL. This eliminated the need to reprint new QR codes, as the reusable QR code can be printed once and the data behind the QR code can be changed, modified, altered, and/or updated.

These QR codes are printed on signs and placed outside of listed homes. When an interested person wants to look at the listing, they simply scan the QR code, enter their contact information, and they gain access to the listing. The contact info is then shared with the listing agent. The QR codes are reusable with a proprietary application, which allows a realtor to change the web URL of the home listing so they can re-use the yard sign over and over from one house listing to another.

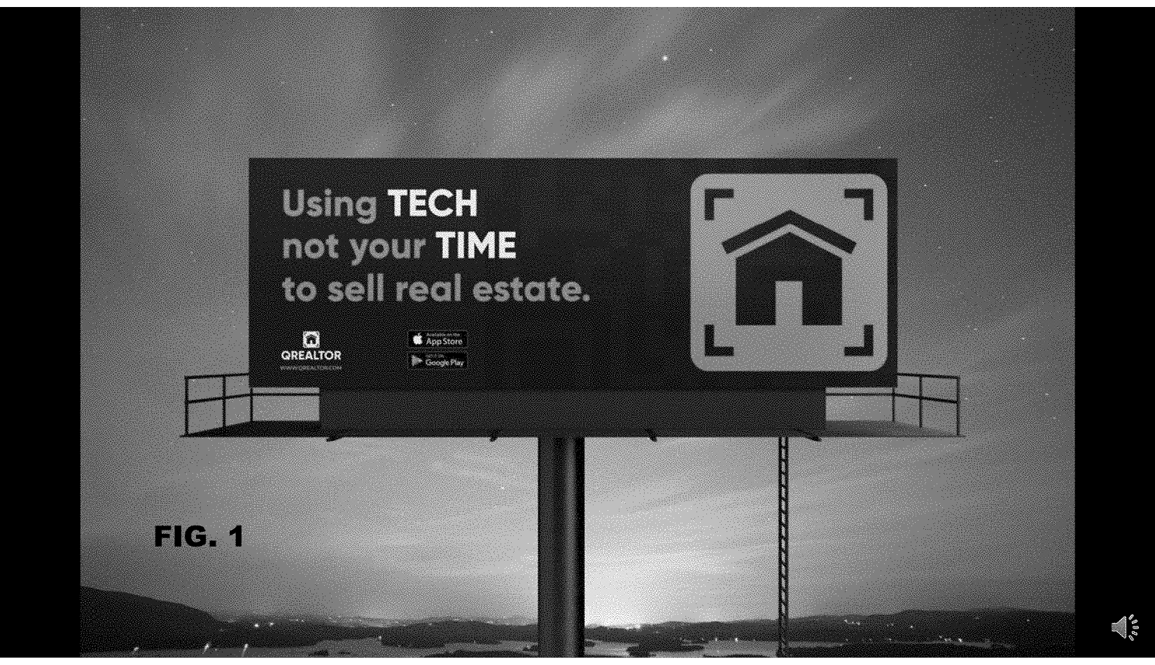

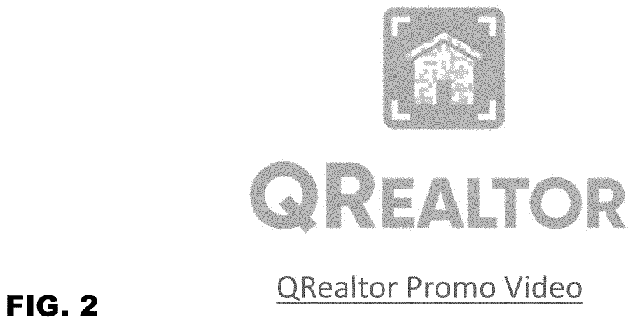

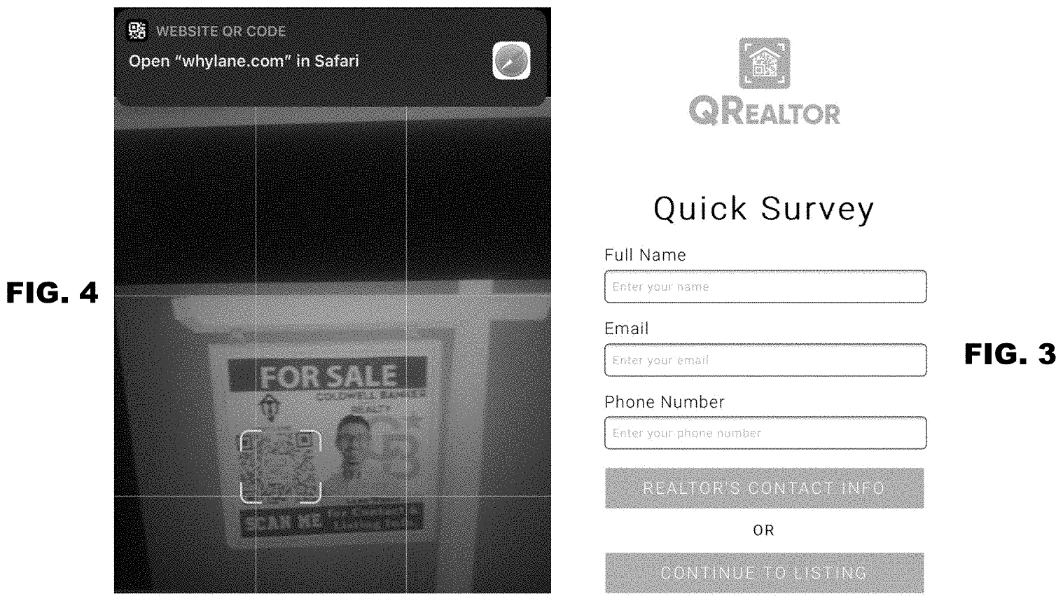

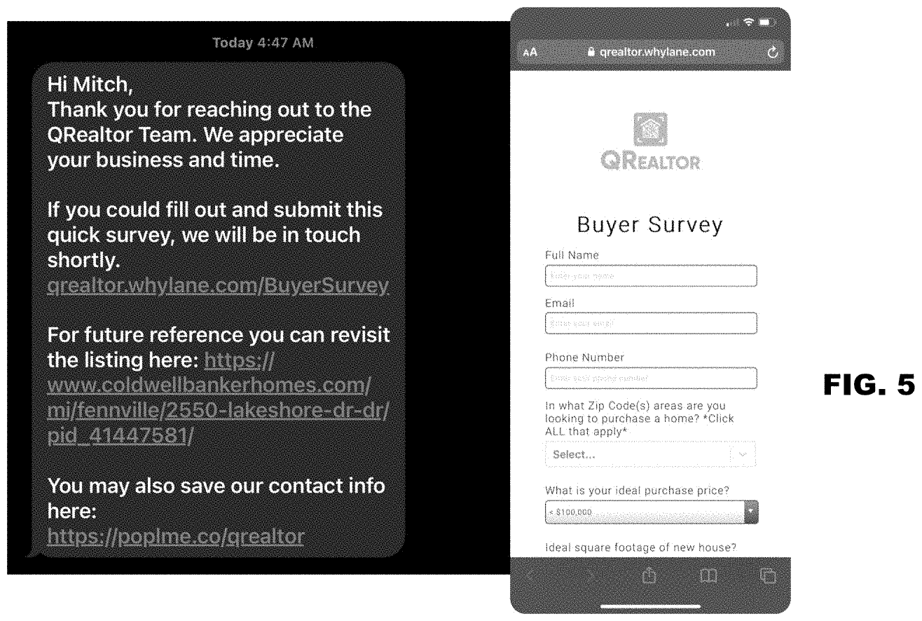

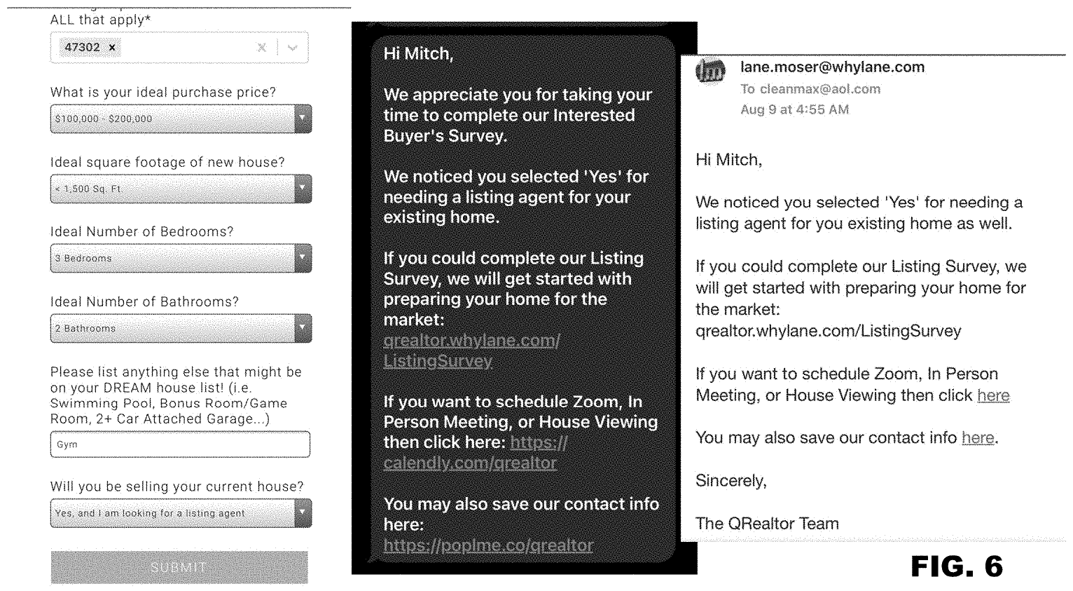

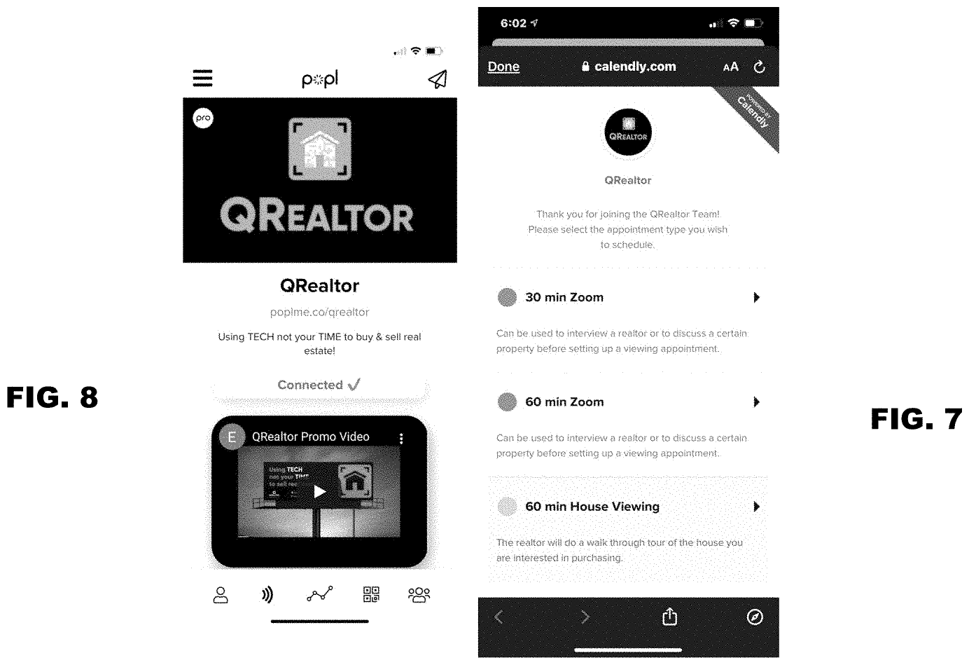

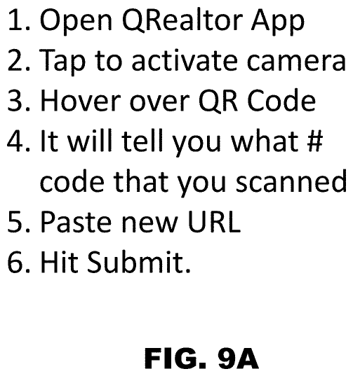

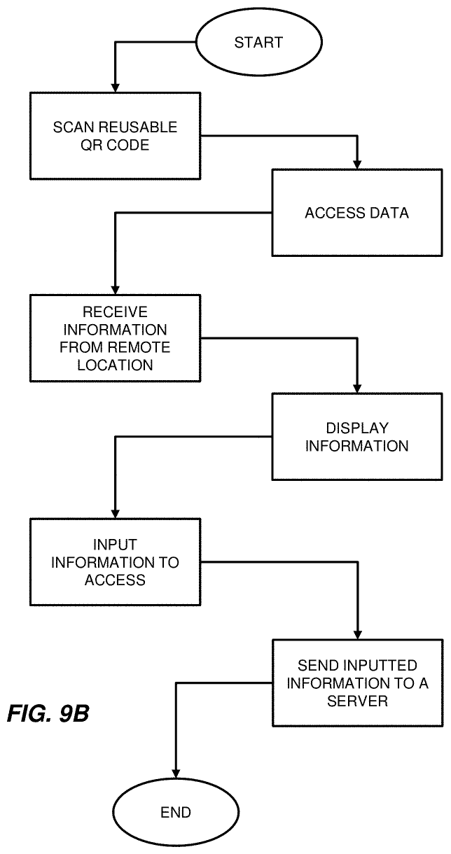

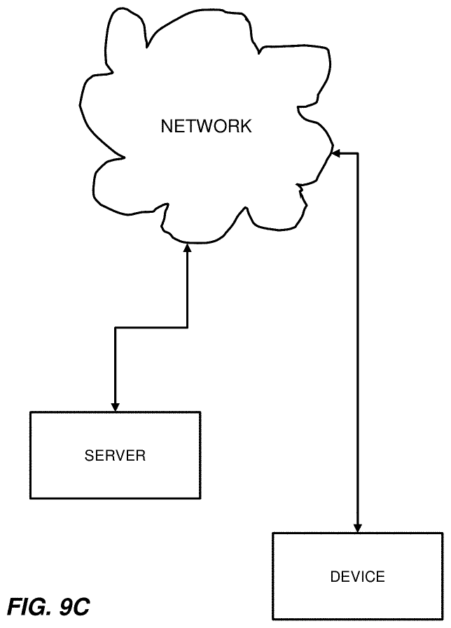

Referring to the FIG. 1 to FIG. 16 in general and specifically, the system and method include reusable QR codes to share contact info & home listings faster while simultaneously becoming a lead generator. In accordance with some aspects and embodiments of the invention, a potential client sees a QRealtor yard sign and uses their wireless device and scans it. Instantly, upon scanning the sign, the user gets the info about the property and is able to share/send to spouse. If the potential new buyer did not love that property, then the potential new byer can fill out a Buyer Survey and give information about their dream house through the wireless device to the realtor or the backend system/server. The system then sends them other matches, they find one they like by viewing a 3D tour. In accordance with some aspects and embodiments of the invention, they (potential new buyer) fill out pre-approval form to make sure they qualify for the price range of home they are considering, then automatically book a viewing with the agent. In accordance with the various aspects and embodiments of the invention, the system fills out a contract for realtor to become their listing agent of their current home and schedule a 30 min video call to discuss putting their home up for sale. This is all done from client's phone within 10 minutes without the agent (intermediary) doing a single thing! The agent receives client info automatically throughout the day by just their yard signs. These clients are then qualified to make sure they are good leads and info is sent to them to sell them their dream house. The same applies to situation related to sale of cars.

For those that want to sell their own home, the system makes digital yard signs, subs out to a sign manufacture and they ship the yard signs directly to the seller of the item. The signs and the system generate leads to their listing. When they get an offer for a buyer, the system sends the digital paperwork to a local broker to finalize title transfer and any documents.

The system allows the realtors to focus on clients by reducing their daily computer tasks by over 95%. This results in efficiency, increase in units sold per month, and less hours weekly spent per house. Data drives the system and modeled responses or output. The benefit is hours saved per week, increase in sales per month, how many leads per month does it generate. The system allows buy/sell of any items, such as a home, while remaining 100% contactless during these COVID times. Increases efficiency & communication thus dramatically decreases the fees associated with buying an item, such as a car or a home. Various type of sales models or subscribers can be handled by the system. In accordance with some aspects and embodiments of the invention, the system allows car dealerships to build client list every time someone scans a QR code for a car, sell cars even when lot is closed, and helps build a list of cars people are interested so when they attend auctions, they have a “queued” list. Adds digital features to analog car dealerships so they can compete with Carvana & Vroom that sell autos completely automated! For example, the system includes:

A. Automatically builds a customer base even people that don't want to talk to salesman.

B. Allows building a trade in or auction list so you can purchase more wisely. Might even be able to sell the vehicle to a customer before buying in at the auction.

C. Allows “virtual salesman” even when car dealerships close after hours.

D. Implementable in states that don't allow car sales on Sundays; allows you to do everything but sign the contract, which can be done on Monday.

E. Allows you to schedule viewings, test drives scheduled. Just like Pre-approval, financing, insurance, etc. can all be scheduled and discussed through software.

No more sharing the other companies involved and eliminates the email triangle headache!

F. If the car they scan they don't buy, then they fill out “dream auto” survey and it matches autos to their inventory just like MLS matches houses . . . . In accordance with some embodiments, the system sets up “scrumming” bots to find the auto they are looking for automatically on the top 5 websites. The system then auto texts/emails the buyer the vehicle without a salesman doing a single manual search!

G. Promo video and as the data comes in from the car dealership, the vide is sent to buyers.

H. The QR codes are loaded on the T-shirt that are worn to auctions so they can network and find vehicles for others as shown in FIG. 10.

There are various tiers of subscribers for the services. For example, three tiers of monthly subscription, such as:
A. $49/month (everything mentioned above & in video);
B. $74/month (A plus automating the MLS matching so no more manual searching from spreadsheet to MLS database); and
C. $99/month (additional features and adding features similar to Realtor.com, Zillow, Redfin . . . etc.).

In accordance with the various aspects and embodiments of the invention, additional revenue streams come into play here (i.e. realtors pay for “features”, ads, exclusivity of their market area, etc.) For example:
For Sale by Owner. They pay a set price ($1-2 k) for yard signs sent to them and a broker processing all of their digital paperwork through the Application. They pay a lower percentage than 6%.
Homeowners that don't want to pay 6% commission fees; these would be offered lower rates, as low as 2% like IdealAgent.com.
Realtors download application and select which Tier subscription. The system goes to another page to allow them to watch demos & sign up for Ad leads online (looking into several companies to see which is the best) and also sign up for online training (Grant Cardone 10X, Craig Proctor, & Jeremy Miner). The system collects a sales fee.

In accordance with the various aspects and embodiments of the invention, the system will be polling the realtors after their 30-day FREE trial to make sure $49/month is not too low. Early feedback is showing the system might want to start at $99/month for tier A. The feedback can come from machine learning and artificial intelligence (AI) models and training.

Users can post online with a QR code in the ad with a link in the comment. In accordance with the various aspects and embodiments of the invention, the system will drive potential clients to the CRM. The system will be doing a single click to drive traffic to a CRM and then to an easy way to download the App and view demo and start free 30-day trail.

In accordance with the various aspects and embodiments of the invention, ads online can have a QR code & also a link in case they are on their phone to click on in caption and it will launch them directly into to CRM just like they scanned the yard sign and becomes an auto lead generator. Better conversion rate than any other ad CRM. In accordance with some embodiments and aspects of the invention, QR codes posted online as a “clickable” link, so you don't have to add a link in the comments. Just click on the QR code itself! This makes it easier to produce content to post.

In accordance with some embodiments and aspects of the invention, there are two possible ways: subscription-based for those using the system and the package pricing for those that have a onetime need such as owner sellers that are in the intermediary.

In accordance with some embodiments and aspects of the invention, the advantage of the invention is to save time in dealing with and processing a lot of tasks (such as that done by a realtor or car sales) in the same order and very repetitive from client to client. The resulting method saves 20-30+ hr. a week.

In accordance with the various aspects and embodiments of the invention, the system could charge a 1 time “setup” fee with they sign up as well as digital redesign of the yard signs with our QR codes.

In accordance with the various aspects and embodiments of the invention, discounts per realtor could be given if a large brokerage signed up. One main advantage for them doing so is instead of individual agents “owning” those leads/clients that are scanned . . . the brokerage has the data and can divide the leads however they desire.

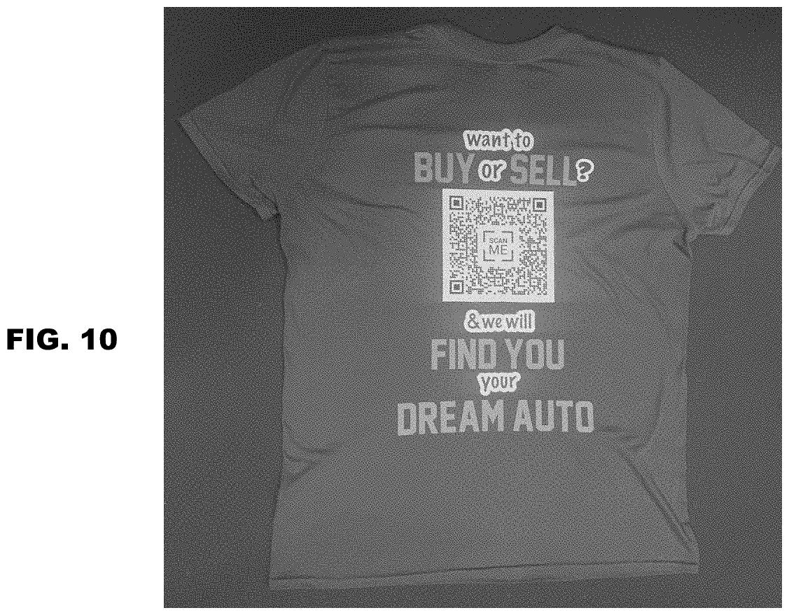

Referring now to FIG. 11, a rack-based server system 1110 is shown, as implemented in various embodiments and as a component of various embodiments. Such servers are useful as source servers, publisher servers, remote servers, cloud-based computer system servers, and servers for various intermediary functions.

Referring now to FIG. 12, a system-on-chip (SoC) 1200 that can be used to implement the various components of the system 100 (shown in FIG. 1) in accordance with the various aspects and embodiments of the invention. The SoC 1200 includes a multi-core computer processor (CPU) 1202 and a multi-core graphics accelerator processor (GPU) 1204. The CPU 1202 and GPU 1204 are connected through an interconnect or a network-on-chip (NoC) 1206 to a DRAM interface 1208 and a Flash RAM interface 1210. A display interface 1214 controls a display, enabling the system to output Motion Picture Experts Group (MPEG) video and Joint Picture Experts Group (JPEG) still image message content. An I/O interface 1216 provides for speaker and microphone access for the human-machine interface of a device controlled by the SoC 1200. A network interface 1212 provides access for the device to communicate with remote providers, servers, and computers using transceivers or wireless or wired communication to remote servers over the internet.

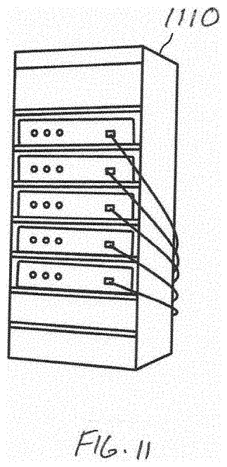

Referring now to FIG. 13, a non-limiting example of a non-transitory computer readable rotating disk medium 1300 is shown. The medium 1300 stores computer code that, if executed by a computer processor, would cause the computer processor to perform methods or partial method steps described herein in accordance with various aspects of the invention.

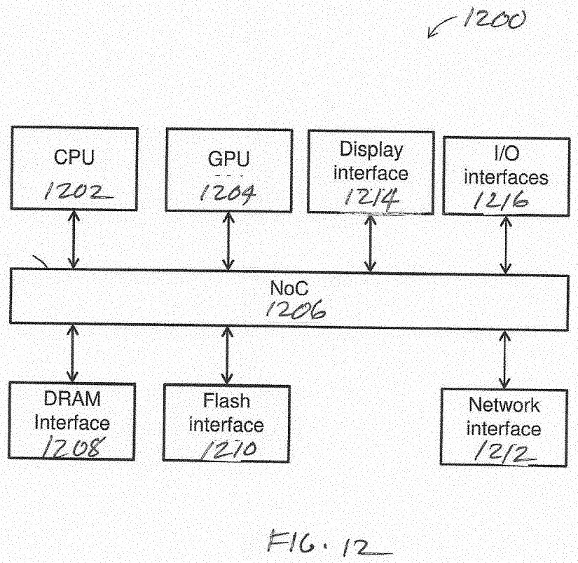

Referring now to FIG. 14, a non-transitory computer readable Flash random access memory (RAM) chip medium 1400 is shown. The medium 1400 stores computer code that, if executed by a computer processor, would cause the computer processor to perform methods or partial method steps described herein in accordance with various aspects of the invention.

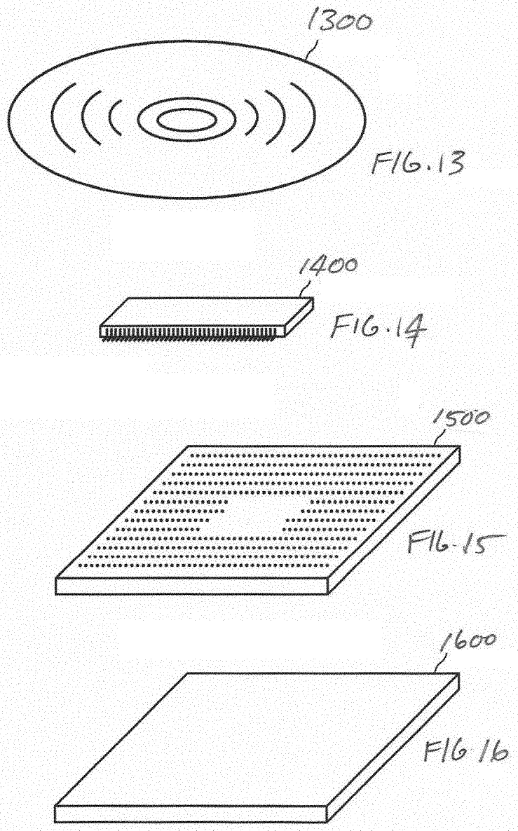

Referring now to FIG. 15, a bottom side of a packaged system-on-chip (SoC) 1500 is shown. The SoC 1500 includes multiple computer processor cores that have a component of some embodiments and that, by executing computer code, perform methods or partial method steps described herein in accordance with various aspects of the invention.

Referring now to FIG. 16, a top side 1600 of the SoC 1500 (FIG. 15) is shown in accordance with various aspects and embodiments of the invention.

Some embodiments of the invention are cloud-based systems. They are implemented with, and controlled by, a server processor, FPGA, custom ASIC, or other processing device. Such systems also comprise one or more digital storage media such as a hard disk drive, flash drive, solid-state storage device, CD-ROM, floppy disk, or box of punch cards.

In accordance with some aspects and embodiments, the system includes QR Marketer as a way to market any asset, product or service. QR Marketer is the software platform that ALL other QR companies are powered by. In accordance with some aspects and embodiments of the invention, QRealtor is using the software platform of QR Marketer to run that application and provide SaaS. The system and methos in accordance with the various aspects and embodiment of the invention includes application of this disclosure to companies that can launch and run effectively based on the systems and methods herein.

In accordance with some aspects and embodiments, QR code application to the automobile industry allows car dealerships to have features that enhance the purchase experience and process. For example, this can be an auto lead generator when the dealership is closed or when someone doesn't want to talk to a car salesman. This allows one to schedule a test drive within seconds, allows the buyer to know what the buyer is pre-approved for and what the monthly payments would be, in a short period of time. In accordance with some aspects and embodiments, this allows you to sign a contract to buy or lease without talking to a single salesman. In accordance with some aspects and embodiments, this adds digital features to analog car dealerships so they can compete with other car selling platforms, such as Carvana & Vroom, which sell autos completely automated. In accordance with some aspects and embodiments, similar process as used with real estate sales, noted herein, is adapted to selling cars and to car dealerships: it would in effect be like substituting realtors with car salesmen and houses with autos. Just replace realtors with car salesmen/car dealerships and houses with autos. In accordance with some aspects and embodiments, the invention allows car dealerships to build client list every time someone scans a car, sell cars even when the lot is closed. This helps build a list of cars, in which people are interested, so when the dealer attends car auctions, then the dealer can make purchasing decision based on having a “queued” list or potential buyers. In accordance with some aspects and embodiments, digital features are added to analog car dealerships so they can compete with various car sale platforms that sell autos completely automated.

In accordance with some aspects and embodiments, various features include:
A. Automatically builds a customer base, including people that don't talk to a salesman.
B. Building a trade in or auction list so you can purchase more wisely. Might even be able to sell the vehicle to a customer before buying in at the auction.
C. Allows “virtual salesman” even when car dealerships close after hours.
D. Some states don't allow you to sell on Sundays. Allows you to do everything but sign the contract on Monday.
E. Allows automated scheduling of test drives. Just like Pre-approval, financing, insurance, etc. can all be scheduled and discussed. No more sharing the other companies involved and eliminates the email triangle headache.
F. If they don't buy the car, they scanned then they fill out a “dream auto” survey and it matches autos to their inventory—similar to the way a home buyer's dream house can be identified or matched to the MLS inventory for houses . . . .

In accordance with some aspects and embodiments, the system implements “scrumming” bots to find the automobile that the buyer is looking (upon request or automatically) on various websites, such as the top 5 websites, and auto texts/emails the buyer of the vehicle without a salesman doing any manual search.

In accordance with some aspects and embodiments, a promo video is not initially needed. As data is collected from the car dealership, promo videos can be generated. This information can also be loaded onto a T-shirt, using a QR code printed on the t-shirt that is reusable, that the dealer can wear to auctions so that other dealers at the auction scan and network and find vehicles for others.

In accordance with some aspects and embodiments, another marketing options is to use QR codes for rental. QR codes for rental can be used for handling rental of items, such as housing or goods. For example campus rentals, wherein people can see videos, get driving directions, and complete the rental process.

In accordance with some aspects and embodiments, QR for Politician allows someone to scan a political sign and immediately get access to information about the politician, including contact info, 5 core values, and even donate to their campaign within seconds.

In accordance with some aspects and embodiments, QR for construction allows any construction or service company to put a yard sign in the customers' yard while they are performing work. Once the QR code is scanned, it will auto generate leads for the company.

In accordance with some aspects and embodiments, QR Remodel allows people driving by to see the progress & the quality of work, get contact info, and even schedule a time for an estimate or submit pics/videos so company can remotely give the potential customer an instant proposal. Thus, a potential new customer is identified, and a lead is generated as the potential new customer provides contact information for follow-up.

In accordance with some aspects and embodiments, QR Plumber is a platform that works for any and all service industry companies. The platform allows branding and is instantly launched using the “white labeling” platform.

In accordance with some aspects and embodiments, QR Barber would for example allow services provided by a barber and all other related services or products to be provide in order to benefit the barber. The customer would scan the barber's sign and the customer can schedule the appointment in seconds, thereby eliminating the slower and time-consuming process of telephone calls to schedule the appointment.!

In accordance with some aspects and embodiments, a QR Digital version that includes a link in the ad or in comment of a post that once they click takes them to the exact CRM and continues just like the scanned QR code with camera. This simplifies and provides the benefit of making marketing and advertising more efficient and effective because this uses one ad (entry point) for all advertising by putting a QR code on the ad as well as link somewhere inside the post.

In accordance with some aspects and embodiments, the QR code “itself” is clickable as the link, thereby allowing scanning and clicking of the QR code image. For example, when a phone sees QR code it is clickable; the phone registers it just like when using camera and pops up a notification that is clickable.

In accordance with some aspects and embodiments, a clickable QR code includes the ability to using advertising by allowing a user to quickly copy QR codes “URL” and add it to the digital ad putting, such as by placing it in comments, mentions, bios, or other places depending on the social media platform.

In accordance with some aspects and embodiments, QR codes are implement is placing orders or goods or services. One approach is using EZ order. The customer is able to place an order, such for drinks, from table using QR codes within seconds. In accordance with some aspects and embodiments, NFC tags is used, and orders are placed within seconds. The various aspects and embodiments of the invention provide an All-In-One point of sale (POS) with notifications to/from servers and hostess as well as any other person.

In accordance with some aspects and embodiments, QR codes can be used to tip or provide additional compensation to the workers/servers at the establishment. The system allows the customer to scan a QR code and with 1 step (action/click) the customer is able to pay and tip any server, waitress, valet, housekeeping, casino dealer, etc. The advantage or benefit is that the processes in accordance with the aspects and embodiments of the invention eliminate the numerous steps (7-9 step process) of manually entering data to make that payment, the handling and back-and-forth shuffling of credit cards or cash, and the final collection of the paperwork that is signed by the customer for later processing. In accordance with some aspects and embodiments, additional sources of funding can be associated with the AR codes, such as various electronic payment systems like PayPal (and with it credit cards) and other payment platforms. After the QR code is scanned then the system provides a landing page with icons of all of the digital payment options. Once the customer clicks on which they prefer. Then the system automates all of the process besides the green swipe payment.

In accordance with some aspects and embodiments, NFC tags are presented as or combined with a sticker placed on top. The sticker can include any instruction, such as “TAP to Order” and when a phone comes near that NFC tag it automates everything in the payment process. The system can automate the process so that the customer or user taps an NFC tag instead of opening the camera App and scanning a QR code. One example is shown at:
https://youtube.com/shorts/rPgO17ge6cQ?feature=share

In accordance with some aspects and embodiments, the use of mask requirement with Delta strain outbreak is now a go time for EZ Order & The App Lounge! The use of QR codes changes and enhances the way people experience restaurants. People are adapting since COVID and now is the time to position a solution that is COVID “resistant.” Since the 50's customer service has tanked while “tabletop turnover” per dinner service has reduced all while we have “better/faster” POS systems. Additionally, the customer has been ignored and not valued like they should. Furthermore, during COVID customer are acknowledged by the waitress when they are seated, and an extensive period of time passes before an order is placed; this results in a longer time before food or beverage is served.

In accordance with some aspects and embodiments, using QR codes or NFC results in faster, cheaper (no terminals needed) & minimal hardware. Additionally, given the lack of work staff during COVID problem, a cashless process is implemented that reduces the number of staff needed and reduces direct contact points between the staff and the customer. For example and in accordance with some aspects and embodiments, there is a reduction of over 90% (specifically based on recent analysis and as a non-limiting example reduction is 92%) of “steps” associated with point-of-sale (POS) devices and over 68% reduction in time allotted to providing a drink service. Thus, the various advantages of the system and process of the current invention reduces staff needs and increase delivery speed (reduces waiting time) of orders, for example drinks, per hour by multiple factors.

Advantages includes: minimizes staff; makes staff more efficient so they spend dramatically less time at a terminal entering orders; number of orders or drinks delivered per hour increases; reduces problem with customers failing to pay tabs, walking outs, running up a huge tab on a bad credit card as each order is paid for as the order is placed; reduces the number of times a server is in direct contact with the customer; allows a service provider or restaurant to make the setting completely cashless and avoid the credit card processing fees; eliminate customers waiting in a line (with the benefit of reducing customer to customer close contact and keeping social distancing) at a bar or trying to flag down a waitress, especially during busy periods; connects directly to the service providers current POS system to sell full food & drink menu; ability to reorder items is second from table so that immediate ordering can take place; and servers that roam the facility and sell items from a tray more efficiently as customers scan a QR code on the server's shirt, the customer then grabs the food item so or product or drink item off the server's tray. In accordance with some aspects of the invention, the shirt includes multiple QR codes based on the number of items on the tray of the server. Thus, any number of the QR codes may be scanned depending on the items being purchased or the quantity of items purchased.

In accordance with some aspects and embodiments, some aspects and embodiments are demonstrated at the following video content:
https://tinyurl.com/The-App-Lounge---VP-Survey
https://youtube.com/shorts/BqG-a1SorSk?feature=share
https://youtu.be/_iLdWH_hdnM (in full screen so you see the progress bar at top & bottom demonstrating how fast it processes)
https://youtube.com/shorts/pbNTALLpckA?feature=share
https://youtube.com/shorts/XuXCpkKppG0?feature=share
https://youtube.com/shorts/dyvm8OAsJm4?feature=share
https://youtube.com/shorts/C5GcfLzi1aY?feature=share
https://youtube.com/shorts/O91QeasuEoc?feature=share
https://tinyurl.com/EZ-Order-and-QRealtor

In accordance with some aspects and embodiments, the use of a tap feature is implemented in at events, weddings, a birthday party. Various actions or activities or information can be linked to the QR code or NFC tap, including information about the hosts and information for the guests or participants.

In accordance with some aspects and embodiments, additional features can be accessed from a POS to other restaurants/bars first as an add on feature to several current POS systems like UberEats etc. In accordance with some aspects and embodiments, features include:
1) determining when a customer base (using surveys or questionnaires) is planning on coming to bar and on those nights have customer base “vote” what vibe they would like to see that night and based on the top result, the establishment is turned into that vibe for a period of time, such as Sports, UFC, karaoke, trivia night, dance floor/nightclub). The establishment can “Adapt” to YOU! The advantage is that the customer has input and feels that their opinion matters and is being considered. Another advantage is that this creates locality like a restaurant/bar has never seen before.
2) providing special pricings or services for a period of time. This allows for price offering that is dynamic and adaptive to the local competition and beat the competition in having/providing the best vibe, the fastest service, and the lowest prices for goods/services.
3) providing transportation services, such as a party bus, to make sure everyone gets home safe. The advantage is that people meet at a central location (house of one person) and come as a large group and stay longer at the establishment. Using the system (QR codes or NFC tags) the customers can reserve tables through the system, order drinks, order food, order special services.
The advantage is that the moment the customer walks into the establishment, the orders or requests are immediately available. Another advantage is that the timing of the arrival of the customer is tracked and known using GPS tracking, so that the services or goods and prepared at the right timing for the customer's arrival

In accordance with some aspects and embodiments, information related to medical history of a person can be accessed and delivered using QR code and NFC reading for medical service providers. In accordance with some aspects and embodiments, patients use digital Medical ID that a medical provider can “scan” or “swipe” (with a handheld device such as a phone) a bracelet or “sticker” (NFC tag) and immediately get all of the patient's medical data. Example are demonstrated in the link to view video: https://youtu.be/Ca8mpth5JvU

In accordance with some aspects and embodiments, the system is deployed in coordination with care providers. For example, hospitals/ER pay for bracelets/tags and then setup for patients before leaving. The advantage is that the hospitals can have patients “check in” to doctors Appt/ER without needed administrative support and reducing direct contact in a setting where social distancing is important. The patient can walk up and scan/swipe past a reader type device to check-in. All the necessary data is sent to the service provider.

In accordance with some aspects and embodiments, the user or patient can select a setting to control the information provided; the patient can allow all or a limited portion of the information to be shared and sent. In accordance with some aspects and embodiments, the check-in would be simplified: 1) scan a QR code; 2) the patient enters information as needed; 3) the patient can request additional assistance, for example there would be a button for assistance.

In accordance with some aspects and embodiments, the system is deployed to hospice, nursing homes, assisted living so when they have to call ambulance the EMT gets all data in route from the scanned information of the patient. One advantage is the replacement of intermediary companies, such as LifeAlert and the “I have fallen and I can't get up!”

In accordance with some aspects and embodiments, the system links digital medical ID with panoptic software that detects and controls traffic lights for a panoptic 911 dispatch for emergency vehicle services. The advantage is that all emergency service providers will be dispatched and will avoid a red light, which is one of the most dangerous things an emergency service vehicle does while driving to a location (drive on the wrong side of the road and going through a red light). Another advantage is that the system will reduce 911 dispatchers and make data transfer WAY faster & eliminates errors.

In accordance with some aspects and embodiments, the panoptic 911 dispatch system and application includes four buttons: ALL, Police, Fire, and Ambulance. After a call is made for emergency services, when any button is pressed by the patient or user, then all of the user's preset data (like GPS, phone number, digital medical ID) will be sent to all emergency services while in route. The advantage is that this dramatically reduces dispatch time, it also allows the emergency service provider, like an EMT, to arrive on-site with the necessary equipment in hand, such as walk into a house with a defibrillator instead of having to walk back out to grab it. Another advantage is that the emergency service provider, such as the police, would have additional medical condition information; this allows the police to wear necessary protective gear before entering to provide assistance. For example, the police would know if someone has an infectious disease, to ensure they glove-up before entering a domestic violence report.

In accordance with some aspects and embodiments, the system for panoptic for dispatching non-emergency vehicles includes a dashboard tracking system for business vehicles that is color coded. For example, electricians are red, plumbers blue, landscapers green, roofers black, etc. In accordance with some aspects and embodiments, the system for panoptic for dispatching emergency vehicles includes a dashboard tracking system for the vehicles that is color coded. For example, police blue, firetrucks red, and ambulances green.

Some embodiments access information and data from remote or third-party sources. Cloud-based embodiments have network interfaces that interact with network endpoint devices such as mobile phones, automobiles, kiosk terminals, and other voice-enabled devices.

Embodiments of the invention described herein are merely exemplary, and should not be construed as limiting of the scope or spirit of the invention as it could be appreciated by those of ordinary skill in the art. The disclosed invention is effectively made or used in any embodiment that includes any novel aspect described herein. All statements herein reciting principles, aspects, and embodiments of the invention are intended to encompass both structural and functional equivalents thereof. It is intended that such equivalents include both currently known equivalents and equivalents developed in the future.

The behavior of either or a combination of humans and machines (instructions that, if executed by one or more computers, would cause the one or more computers to perform methods according to the invention described and claimed and one or more non-transitory computer readable media arranged to store such instructions) embody methods described and claimed herein. Each of more than one non-transitory computer readable medium needed to practice the invention described and claimed herein alone embodies the invention.

Some embodiments of physical machines described and claimed herein are programmable in numerous variables, combinations of which provide essentially an infinite variety of operating behaviors. Some embodiments of hardware description language representations described and claimed herein are configured by software tools that provide numerous parameters, combinations of which provide for essentially an infinite variety of physical machine embodiments of the invention described and claimed. Methods of using such software tools to configure hardware description language representations embody the invention described and claimed. Physical machines, such as semiconductor chips; hardware description language representations of the logical or functional behavior of machines according to the invention described and claimed; and one or more non-transitory computer readable media arranged to store such hardware description language representations all can embody machines described and claimed herein.

In accordance with the teachings of the invention, a system, a computer, and a device are articles of manufacture. Other examples of an article of manufacture include: an electronic component residing on a mother board, a server, a mainframe computer, or other special purpose computer each having one or more processors (e.g., a Central Processing Unit, a Graphical Processing Unit, or a microprocessor) that is configured to execute a computer readable program code (e.g., an algorithm, hardware, firmware, and/or software) to receive data, transmit data, store data, or perform methods.

Article of manufacture (e.g., computer, system, or device) includes a non-transitory computer readable medium or storage that may include a series of instructions, such as computer readable program steps or code encoded therein. In certain aspects of the invention, the non-transitory computer readable medium includes one or more data repositories. Thus, in certain embodiments that are in accordance with any aspect of the invention, computer readable program code (or code) is encoded in a non-transitory computer readable medium of the computing device. The processor or a module, in turn, executes the computer readable program code to create or amend an existing computer-aided design using a tool. The term “module” as used herein may refer to one or more circuits, components, registers, processors, software subroutines, or any combination thereof. In other aspects of the embodiments, the creation or amendment of the computer-aided design is implemented as a web-based software application in which portions of the data related to the computer-aided design or the tool or the computer readable program code are received or transmitted to a computing device of a host.

An article of manufacture or system, in accordance with various aspects of the invention, is implemented in a variety of ways: with one or more distinct processors or microprocessors, volatile and/or non-volatile memory and peripherals or peripheral controllers; with an integrated microcontroller, which has a processor, local volatile and non-volatile memory, peripherals and input/output pins; discrete logic which implements a fixed version of the article of manufacture or system; and programmable logic which implements a version of the article of manufacture or system which can be reprogrammed either through a local or remote interface. Such logic could implement a control system either in logic or via a set of commands executed by a processor.

The scope of the present invention, therefore, is not intended to be limited to the exemplary embodiments shown and described herein. Rather, the scope and spirit of present invention is embodied by the appended claims.

What is claimed is:

1. A method for using a wireless device, the method comprising:
scanning, using the wireless device, a reusable QR code;
accessing, from the wireless device, data associated with the reusable QR code from a remote location;
receiving information from the remote location at the wireless device based on the reusable QR code;
displaying the information on the wireless device;
inputting information to the wireless device to access a product, good, or services that is associated with the scanned reusable QR code; and
sending the inputted information to a server to complete an action.

2. A system comprising:
a server in communication with a network;
a device in communication with the network,
wherein the device reads a reusable QR code and sends a request to the server, which is based on the reusable QR code, for information that is provided by the server in response to the request, and
wherein the information from the server is displayed by the device for user interaction to make additional selections.
